(19) United States
(12) Patent Application Publication
(10) Pub. No.: US 2012/0073528 A1
(43) Pub. Date: Mar. 29, 2012

(54) Cylinder Head Having Water Jacket

(75) Inventors: Jong Bae KIM, Ulsan-si (KR); Jin Wook Son, Suwon-si (KR); Boyng Seuk Lee, Hwaseong-si (KR); Jay Kee Lee, Ulsan-si (KR); Jin Kook Kong, Suwon-si (KR); Young Nam Kim, Seongnam-si (KR); Young Jin Won, Hwaseong-si (KR)

(73) Assignee: HYUNDAI MOTOR COMPANY, Seoul (KR)

(21) Appl. No.: 12/958,137

(22) Filed: Dec. 1, 2010

(30) Foreign Application Priority Data
Sep. 29, 2010 (KR) 10-2010-0094718
Sep. 29, 2010 (KR) 10-2010-0094720
Oct. 15, 2010 (KR) 10-2010-0101056

(51) Int. Cl. F02F 1/40; B22D 17/00

(52) U.S. Cl. 123/41.82 R; 164/113

(57) ABSTRACT

A cylinder head having a water jacket may include a cylinder head in which a combustion chamber may be formed, and a protruding portion that may be integrally formed with the cylinder head and an exhaust outlet portion may be formed in an outer surface thereof to communicate with the combustion chamber, wherein the water jacket may be formed inside the protruding portion at an upper side and a lower side of an exhaust passage that may be aligned through the exhaust outlet portion, the water jacket having an upper water jacket formed between the upper side of the exhaust passage and an upper surface of the protruding portion, a lower water jacket formed between the lower side of the exhaust passage and a lower surface of the protruding portion, and a connection water jacket connecting the upper water jacket and the lower water jacket in the protruding portion.

### CROSS-REFERENCE TO RELATED APPLICATION

The present application claims priority to Korean Patent Application No. 10-2010-0094718, 10-2010-0101056, and 10-2010-0094720 filed in the Korean Intellectual Property Office on Sep. 29, Oct. 15, and Sep. 29, 2010, the entire contents of which is incorporated herein for all purposes by this reference.

### BACKGROUND OF THE INVENTION

1. Field of the Invention

The present invention relates to a cylinder head having a water jacket. More particularly, the present invention relates to a cylinder head having a water jacket cooling a cylinder head and an exhaust manifold.

2. Description of Related Art

Generally, an exhaust manifold as a separate component is mounted on a cylinder head and is to be disposed closely to the cylinder head such that a catalyst is quickly activated.

Recently, a cylinder head that an exhaust manifold is integrally formed therein has been developed to be applied and cooling structure is being developed to effectively cool the protruding portion as an exhaust manifold.

Particularly, high temperature exhaust gas exhausted from combustion chamber flows through the protruding portion and it is important to effectively cool the high temperature exhaust gas so as to control the flowing thereof.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a cylinder head having a water jacket having advantages of having a water jacket for effectively cooling an exhaust manifold through which hot exhaust gas is exhausted to as to improve cooling performance of an engine.

In an aspect of the present invention, the cylinder head having a water jacket, may include a cylinder head in which a combustion chamber may be formed, and a protruding portion that may be integrally formed with the cylinder head and an exhaust outlet portion may be formed in an outer surface thereof to communicate with the combustion chamber, wherein the water jacket may be formed inside the protruding portion at an upper side and a lower side of an exhaust passage that may be aligned through the exhaust outlet portion, the water jacket including an upper water jacket formed between the upper side of the exhaust passage and an upper surface of the protruding portion, a lower water jacket formed between the lower side of the exhaust passage and a lower surface of the protruding portion, and a connection water jacket connecting the upper water jacket and the lower water jacket in the protruding portion.

The connection water jacket may be formed along a lateral side surface of the protruding portion in the protruding portion to fluid-connect the upper water jacket with the lower water jacket, wherein the connection water jacket may be formed in the protruding portion except for a portion that the exhaust outlet portion may be formed.

The connection water jacket may be formed in the protruding portion except for a portion that the exhaust outlet portion may be formed.

The exhaust outlet portion may be formed at a central portion of the outer surface of the protruding portion and the connection water jacket may be disposed at both sides of the exhaust outlet portion along a longitudinal direction of the protruding portion.

The exhaust outlet portion may include at least an exhaust outlet that may be disposed in a line with a predetermined distance along a longitudinal direction of the protruding portion.

The connection water jacket may be formed by forming a drill hole in the protruding portion from the upper surface to the lower surface thereof to connect the upper and lower water jackets.

The cylinder head may further include a cap closing an opened portion of the drill hole.

A coolant hole may be formed in a lateral side surface of the protruding portion to fluid-communicate with the connection water jacket.

The cylinder head may further include a cover that may be mounted on the protruding portion to close the coolant hole and to form the connecting water jacket therein, wherein a flange surface may be formed along the coolant hole in the lateral side surface of the protruding portion and the cover may be attached on the flange surface.

The protruding portion may be monolithically formed with the cylinder head.

A manufacturing method of a cylinder head having a water jacket, may include disposing a first core corresponding to an upper water jacket inside a mold, disposing a second core corresponding to a lower water jacket, disposing a third core corresponding to a connection water jacket connecting ends of the upper water jacket and the lower water jacket, disposing a core print supporting the third core, injecting molten metal into the mold, eliminating the core print supporting the third core, and inserting a tapered plug through a hole formed by drawing out the core print.

As stated above, in the cylinder head having a water jacket according to the present invention, the exhaust manifold is integrally formed in one side surface of the cylinder head, water jacket is widely formed at an upper side and at a lower side thereof, and the connection water jacket connects the upper side with the lower side such that the coolant may effectively flow to cool the cylinder head and the protruding portion.

As stated above, in the cylinder head having a water jacket according to the present invention, the connection water jacket is formed by drilling hole such that the coolant may effectively flow the upper jacket and the lower jacket so as to cool the cylinder head.

Particularly, the upper and lower water jacket of the cylinder head is formed by casting process and the upper water jacket and the lower jacket are connected by a simple drill process. Further, the connection water jacket connects the upper jacket and the lower jacket and the connection water jacket is opened to the side of the protruding portion. In this case, the opened cooling hole is closed by the cover such that the assembly and fabrication becomes easier and the maintenance thereof becomes comfortable.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing a cylinder head having a water jacket according to an exemplary embodiment of the present invention.

FIG. 2 is a perspective view of a water jacket formed inside the cylinder head according to an exemplary embodiment of the present invention.

FIG. 3 is a partial cross-sectional view of a cylinder head according to an exemplary embodiment of the present invention.

FIG. 4 is a schematic cross-sectional view showing a condition before injecting molten metal in a casting process for fabricating a cylinder head having a water jacket according to an exemplary embodiment of the present invention.

FIG. 5 is a perspective view of a cylinder head provided in an engine having a water jacket according to an exemplary embodiment of the present invention water jacket.

FIG. 6 is a perspective view showing a water jacket formed in a cylinder head provided in an engine having a water jacket according to an exemplary embodiment of the present invention.

FIG. 7 is a partial exploded perspective view of a cylinder head provided in an engine having a water jacket according to an exemplary embodiment of the present invention.

FIG. 8 is a partial cross-sectional view of a cylinder head provided in an engine having a water jacket according to an exemplary embodiment of the present invention.

FIG. 9 is a perspective view of a cylinder head for a vehicle according to an exemplary embodiment of the present invention.

FIG. 10 is an exploded perspective view of a cylinder head for a vehicle according to an exemplary embodiment of the present invention.

FIG. 11 is a perspective view of a water jacket formed in a cylinder head for a vehicle according to an exemplary embodiment of the present invention.

FIG. 12 is a cross-sectional view along line A-A of FIG. 9 and a partial cross-sectional view of a cylinder head for a vehicle according to an exemplary embodiment of the present invention vehicle.

FIG. 13 is a block diagram showing a cylinder head manufacturing method for a vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

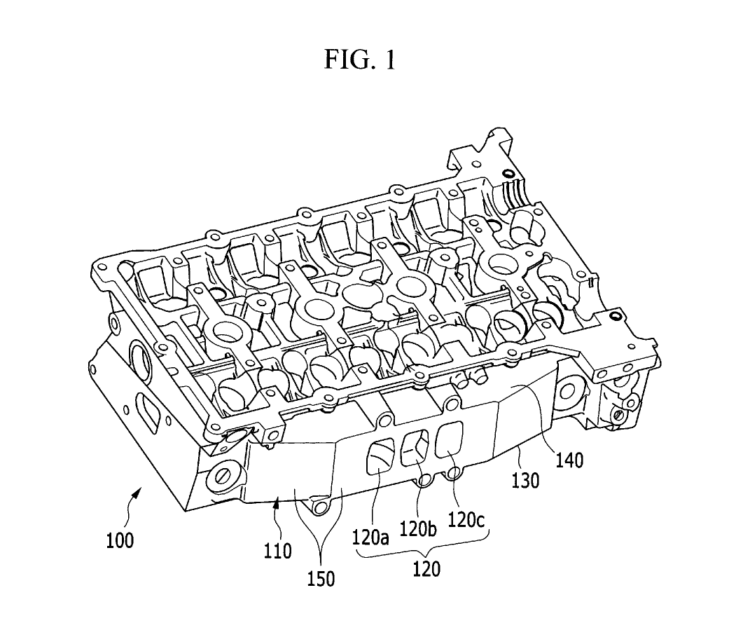

FIG. 1 is a perspective view showing a cylinder head having a water jacket according to an exemplary embodiment of the present invention.

Referring to FIG. 1, a protruding portion 110 is formed on one side surface of a cylinder head 100 having a water jacket.

An exhaust outlet portion 120 is formed at a central portion of one side surface of the protruding portion 110 and the exhaust outlet portion 120 includes a first exhaust outlet 120a, a second exhaust outlet 120b, and a third exhaust outlet 120c.

The first, the second, and the third exhaust outlets 120a, 120b, and 120c are disposed in a row and the first, the second, and the third exhaust outlets 120a, 120b, and 120c are respectively connected to each combustion chamber such that the exhaust gas from the combustion chamber is exhausted through them.

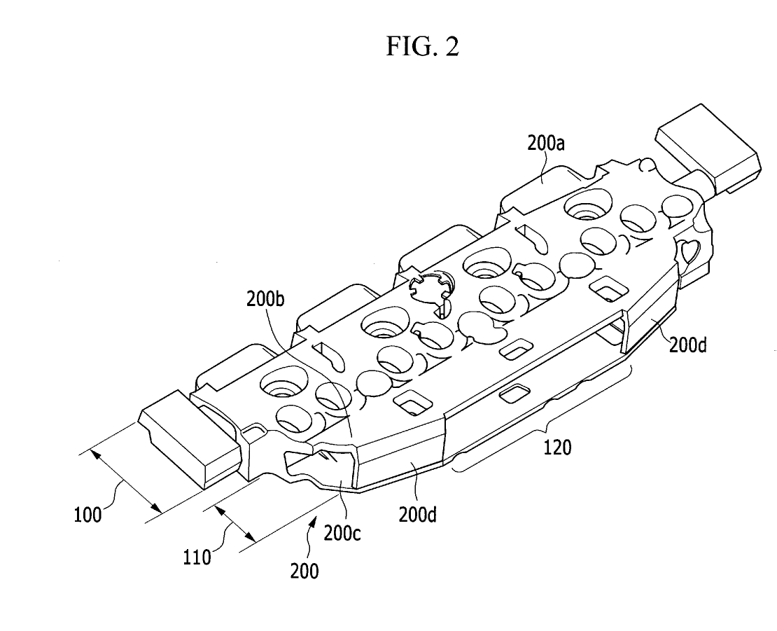

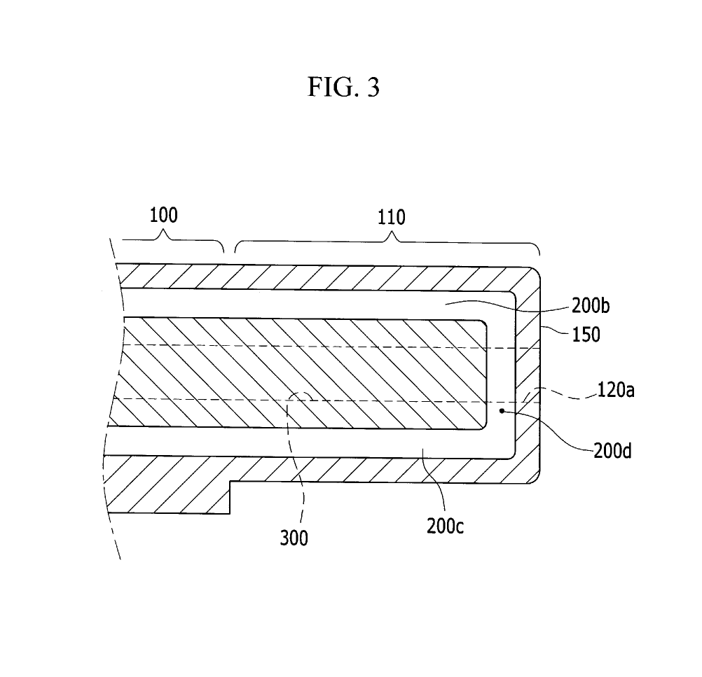

Exhaust passage (300, FIG. 3) is formed inside the protruding portion 110 to connect the combustion chambers with the first, the second, and the third exhaust outlets 120a, 120b, and 120c and a water jacket (200, FIG. 2) is formed around the exhaust passage. The water jacket 200 adequately sustains temperature of the protruding portion 110 heated by the exhaust gas passing the exhaust passage.

Further, the water jacket 200 controls the exhaust gas temperature such that the noise generated due to the exhaust gas is decreased. Referring to FIG. 2 and FIG. 3, shape and structure of the water jacket 200 will be hereinafter described.

FIG. 2 is a perspective view of a water jacket formed inside the cylinder head according to an exemplary embodiment of the present invention.

Referring to FIG. 2, a main water jacket 200a is formed corresponding to the cylinder head 100 and a water jacket 200 is formed corresponding to the protruding portion 110. The main water jacket 200a and the water jacket 200 is integrally formed to be communicated from each other.

The water jacket 200 includes an upper water jacket 200b, a lower water jacket 200c, and a connection water jacket 200d.

The upper water jacket 200b is formed inside the protruding portion along the upper surface of the protruding portion 110, the lower water jacket 200c is formed along the lower surface 130 thereof, and the connection water jacket 200d connects the upper water jacket 200b and the lower water jacket 200c in the protruding portion.

The connection water jacket 200d is formed inside the exhaust manifold along outer side surface thereof, referring to FIG. 2, the connection water jacket 200d is formed at both sides of the exhaust outlet portion 120 and is not formed at a portion that the exhaust outlet portion 120 is formed.

FIG. 3 is a partial cross-sectional view of a cylinder head according to an exemplary embodiment of the present invention.

Referring to FIG. 3, the protruding portion 110 protrudes in a side direction of the cylinder head 100 to be integrally formed with the cylinder head, exhaust passage is formed inside the cylinder head 100 and the protruding portion 110, and the first exhaust outlet 120a is formed at an end portion of the exhaust passage 300.

The upper water jacket 200b is formed at an upper side of the exhaust passage 300, the lower water jacket 200c is formed at a lower side of the exhaust passage 300, and the connection water jacket 200d is formed along the side surface 150 of the protruding portion 110. The connection water jacket 200d integrally connects the upper water jacket 200b with the lower water jacket 200c.

As described above, the protruding portion 110 is integrally formed with the cylinder head 100, the water jacket 200 is widely formed at the upper portion and the lower portion, and the connection water jacket 200d connects them such that the cylinder head 100 and the protruding portion 110 are overall effectively cooled.

Particularly, the upper water jacket 200b and the lower water jacket 200c are formed, in a case that the connection water jacket 200d is not formed, the coolant hardly flows upwards or downwards such that the cooling efficiency is decreased and the exhaust gas temperature does not be uniformly sustained such that the noise of the exhaust gas is raised.

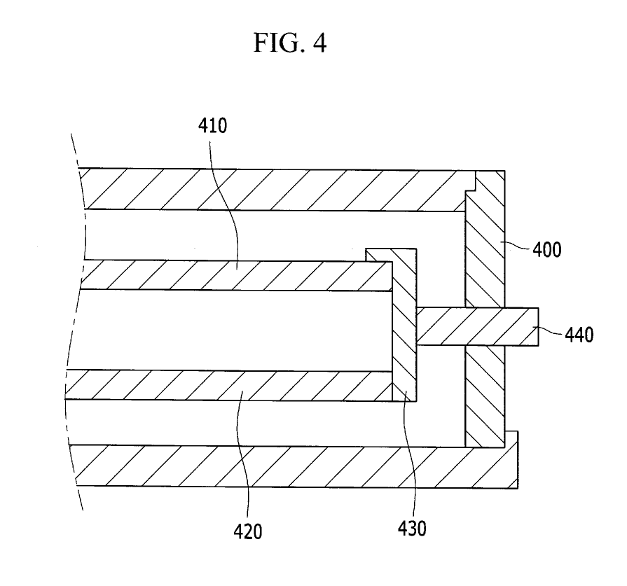

FIG. 4 is a schematic cross-sectional view showing a condition before injecting molten metal in a casting process for fabricating a cylinder head having a water jacket according to an exemplary embodiment of the present invention.

Referring to FIG. 4, a mold 400 is prepared to cast the cylinder head 100, a first core 410 is disposed corresponding to the upper water jacket 200b, a second core 420 is disposed corresponding to the lower water jacket 200c, and a third core 430 having a shape ‘]’ is disposed corresponding to the connection water jacket 200d. Further, a core print 440 is disposed to support the side surface of the third core 430.

The first, the second, and the third core 410, 420, and 430 and the core print 440 are arranged as described above, molten metal is injected in the mold 400, the molten metal is hardened forming the cylinder head 100, and the core print 440 is eliminated. Further, a hole formed by eliminating the core print 440 is closed by a taper plug to be sealed.

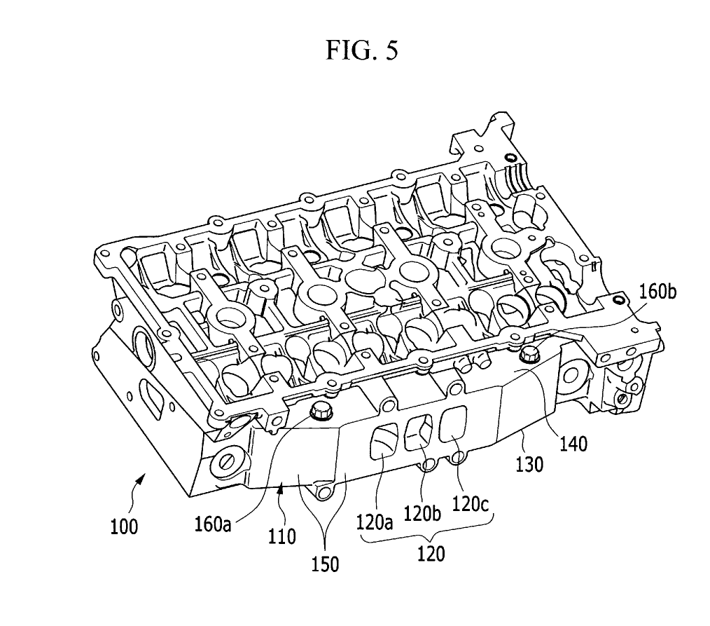

FIG. 5 is a perspective view of a cylinder head provided in an engine having a water jacket according to an exemplary embodiment of the present invention water jacket.

Referring to FIG. 5, an engine includes a cylinder head 100 and a protruding portion 110 is formed at one side of the cylinder head 100.

An exhaust outlet portion 120 is formed in the side surface 150 of the protruding portion 110 and the exhaust outlet portion 120 includes a first exhaust outlet 120a, a second exhaust outlet 120b, and a third exhaust outlet 120c.

The first, second, and third exhaust outlets 120a, 120b, and 120c are respectively connected to combustion chambers of each cylinder and the exhaust gas is transferred to an exhaust line through the exhaust outlets. Further, a first cap 160a and a second cap 160b are disposed at an upper surface 140 of the protruding portion 110.

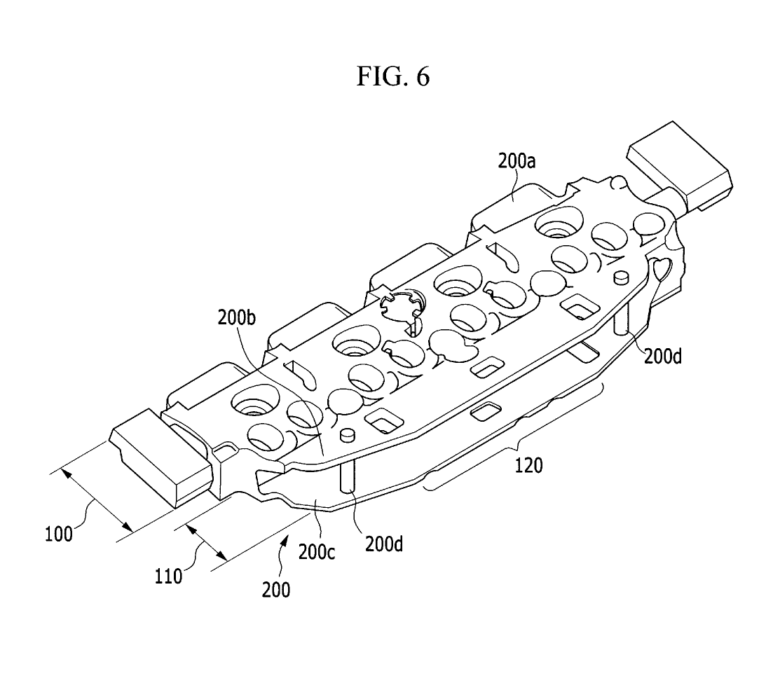

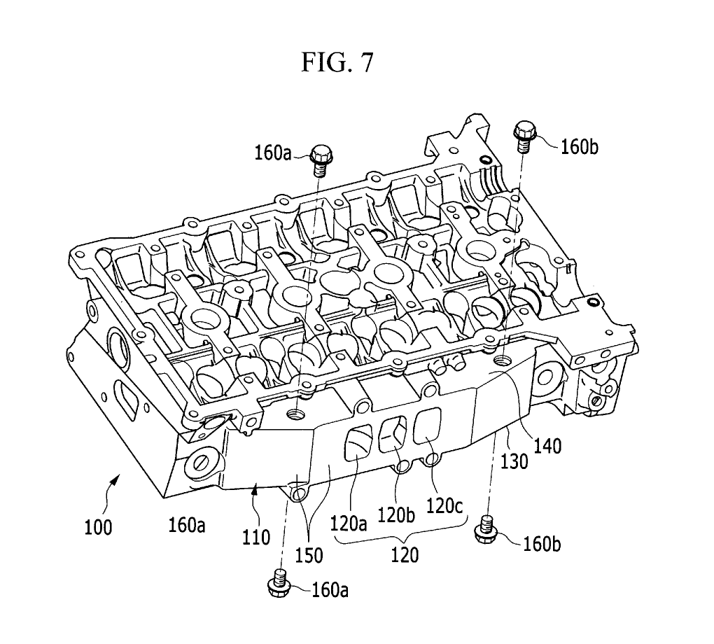

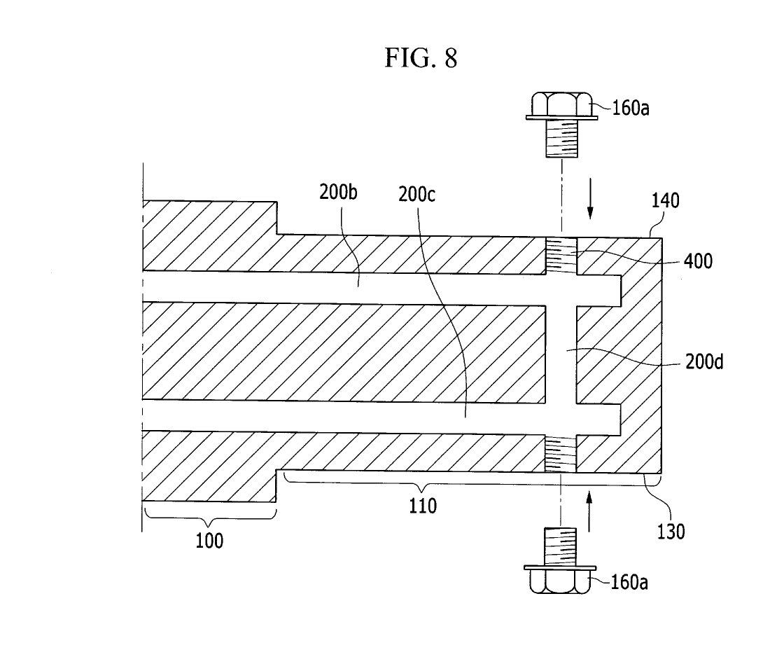

The first cap 160a and the second cap 160b close the drill hole 400 that communicates with the water jacket 200 formed in the protruding portion 110 and with regard to the water jacket 200 and the drill hole 400, it will be hereinafter described, referring to FIG. 6, FIG. 7, and FIG. 8.

FIG. 6 is a perspective view showing a water jacket formed in a cylinder head provided in an engine having a water jacket according to an exemplary embodiment of the present invention.

Referring to FIG. 6, the water jacket 200 is formed inside the cylinder head 100 and the protruding portion 110 and the water jacket 200 includes a main water jacket 200a formed inside the cylinder head 100 and a secondary water jacket 200b, 200c, and 200d inside the protruding portion 110.

The secondary water jacket 200b, 200c, and 200d include an upper water jacket 200b formed inside the protruding portion 110 along the upper surface 140 thereof, a lower water jacket 200c formed inside the protruding portion 110 along the lower surface 130 thereof, and a connection water jacket 200d fluid-connecting the upper water jacket 200b with the lower water jacket 200c in upper/lower direction.

The water jacket is connected by the connection water jacket 200d such that the coolant smoothly flows in upper/lower direction to improve the cooling efficiency.

In the present exemplary embodiment, the connection water jacket 200d is disposed at both sides based on the exhaust outlet portion 120 and the first, the second, and the third exhaust outlets 120a, 120b, and 120c are disposed in a line with a predetermined distance from each other.

FIG. 7 is a partial exploded perspective view of a cylinder head provided in an engine having a water jacket according to an exemplary embodiment of the present invention.

Referring to FIG. 7, the first cap 160a and the second cap 160b are separated from the protruding portion 110 of the cylinder head 100 and the first cap 160a and the second cap 160b close the opened portion from the connection water jacket 200.

FIG. 8 is a partial cross-sectional view of a cylinder head provided in an engine having a water jacket according to an exemplary embodiment of the present invention.

Referring to FIG. 8, the upper water jacket 200b and the lower water jacket 200c are formed inside the protruding portion 110 and a drill hole 400 is formed from the upper surface 140 to the lower surface 130 of the protruding portion 110.

The drill hole 400 is formed so as to form the connection water jacket 200d connecting the upper water jacket 200b and the lower water jacket 200c and the drill hole 400 is formed by drilling the protruding portion 110 from the upper surface 140 to the lower surface 130. Further, the caps 160a close the drill holes 400.

In the present exemplary embodiment, the drill hole 400 is closed by the caps 160a, but the drill hole 400 is welded with a cap having a material equal to the material of the cylinder head 100.

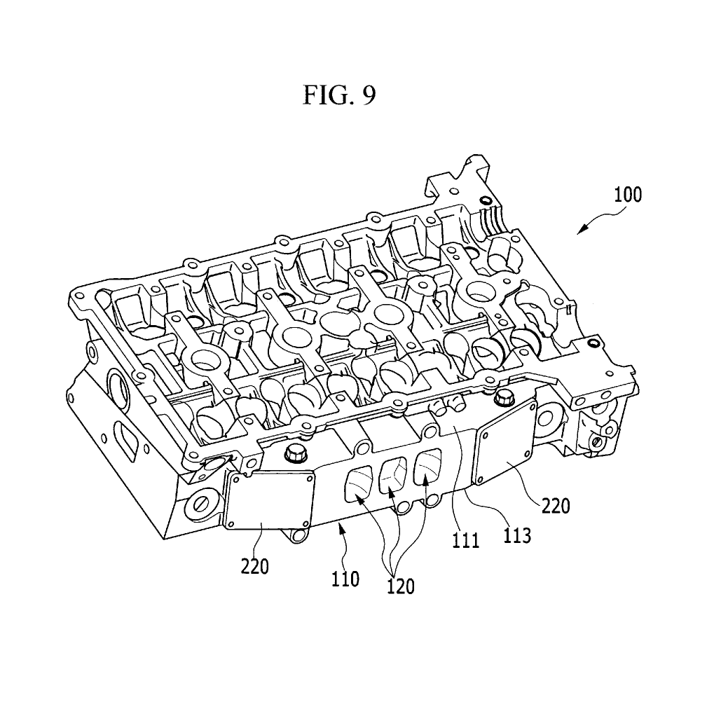

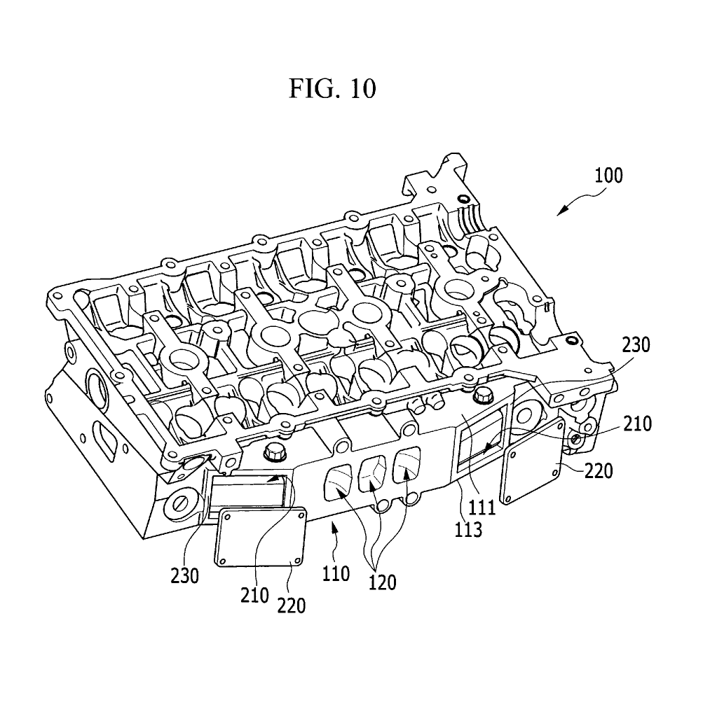

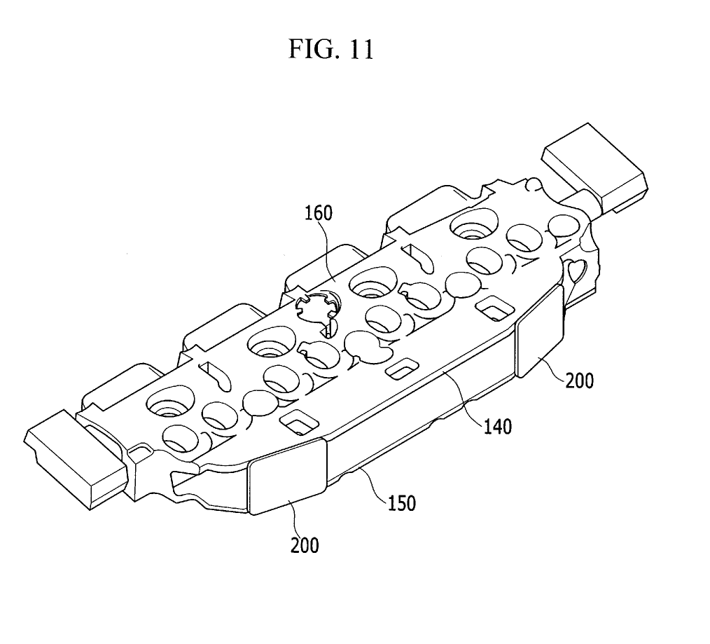

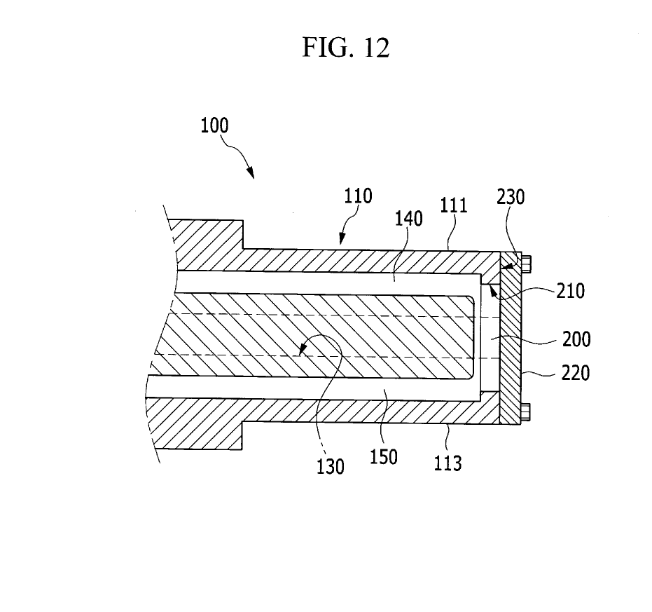

FIG. 9 is a perspective view of a cylinder head for a vehicle according to an exemplary embodiment of the present invention, FIG. 10 is an exploded perspective view of a cylinder head for a vehicle according to an exemplary embodiment of the present invention, FIG. 11 is a perspective view of a water jacket formed in a cylinder head for a vehicle according to an exemplary embodiment of the present invention, and FIG. 12 is a cross-sectional view along line A-A of FIG. 9 and a partial cross-sectional view of a cylinder head for a vehicle according to an exemplary embodiment of the present invention vehicle.

Referring to the drawings, the cylinder head 100 according to an exemplary embodiment of the present invention includes a connection water jacket 200d so as to improve a cooling efficiency thereof.

For this, a cylinder head 100 for a vehicle according to an exemplary embodiment of the present invention vehicle includes at least one of exhaust outlets 120 that is disposed at one side of the protruding portion 110 in a length direction as shown in FIG. 9 and FIG. 10.

In this case, it is desirable that the exhaust outlets 120 are disposed in a line at a central portion of the side surface of the protruding portion 110 with a predetermined distance from each other and three exhaust outlets 120 are prepared in the present exemplary embodiment.

The each exhaust outlet 120 is respectively connected to combustion chamber to exhaust the exhaust gas exhausted from the combustion chamber to an exhaust line.

An exhaust passage 130 is formed inside the protruding portion 110 and an upper and a lower water jacket 200b and 200c are formed at an upper side 111 and a lower side 113 of the exhaust passage 130.

The connection water jacket 200d is disposed at both side based on the exhaust outlet 120 and a coolant hole 210 is formed, which is opened to a side surface of the protruding portion 110. Meanwhile, the coolant hole (cooling hole) 210 is respectively formed at both sides of the protruding portion 110. In the present exemplary embodiment corresponding to the connection water jacket 200d and the number of the coolant holes can be changed according to the design specification.

As shown in FIG. 10, it is desirable that a flange surface 230 is formed on a side surface of the protruding portion along the coolant hole 210.

And, the cover 220 is attached on the flange surface 230 of the side surface of the protruding portion 110 to close the coolant hole 210.

As shown in FIG. 11 and FIG. 12, the connection water jacket 200d connects the upper water jacket 140 with the lower water jacket 150.

In this case, the upper water jacket 140 and the lower water jacket 150 is formed along the upper side and the lower side of the protruding portion 110 and is extended from the main water jacket 160, which is formed inside the cylinder head 100.

The upper water jacket 140 is formed along the upper surface 111 of the protruding portion 110 and the lower water jacket 150 is formed along the lower surface 113 of the protruding portion 110.

The upper and the lower water jackets 140 and 150 that are described above are connected by the connection water jacket 200d such that the coolant flows effectively flows upwards or downwards.

Accordingly, the respective connection water jacket 200d effectively cools the protruding portion 110.

Meanwhile, in the present exemplary embodiment, three exhaust outlet 120 are formed on the protruding portion 110, the number thereof is not limited thereto, and the number of the exhaust outlet 120 can be varied according to a specification of an engine.

Hereinafter, a cylinder head manufacturing method for a vehicle according to an exemplary embodiment of the present invention vehicle.

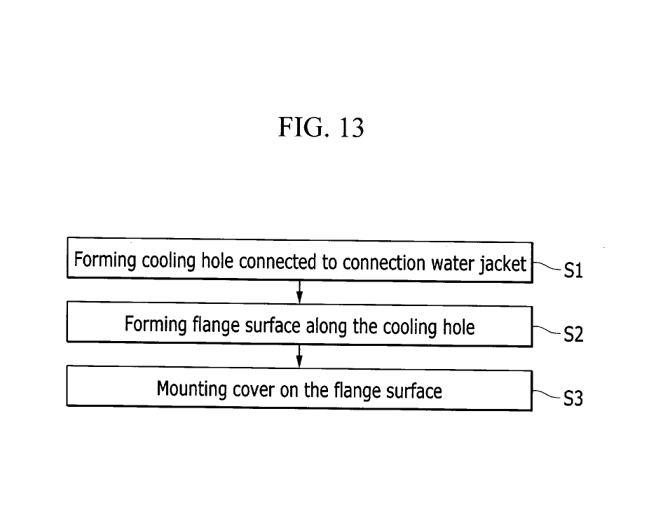

FIG. 13 is a block diagram showing a cylinder head manufacturing method for a vehicle according to an exemplary embodiment of the present invention.

Firstly, a coolant hole 210 is formed at both side of the protruding portion 110 of the cylinder head 100 in a S1.

Subsequently, a flange surface 230 is formed on the outside surface of the protruding portion based on the coolant hole 210 in a S2.

The cover 220 is mounted on the outside surface of the protruding portion 110 corresponding to the coolant hole 210.

Accordingly, if the cylinder head 100 is realized as described above according to an exemplary embodiment of the present invention, the exhaust gas that is exhausted thorough the exhaust outlet 120 is effectively cooled and the overall cooling performance is improved.

Also, a water jacket core is used to form the connection water jacket 200d and the coolant hole 210 that is connected to the connection water jacket 200d in the cylinder head 100.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A cylinder head having a water jacket, comprising:
a cylinder head in which a combustion chamber is formed; and
a protruding portion that is integrally formed with the cylinder head and an exhaust outlet portion is formed in an outer surface thereof to communicate with the combustion chamber,
wherein the water jacket is formed inside the protruding portion at an upper side and a lower side of an exhaust passage that is aligned through the exhaust outlet portion, the water jacket including:
an upper water jacket formed between the upper side of the exhaust passage and an upper surface of the protruding portion;
a lower water jacket formed between the lower side of the exhaust passage and a lower surface of the protruding portion; and
a connection water jacket connecting the upper water jacket and the lower water jacket in the protruding portion.

2. The cylinder head of claim 1, wherein the connection water jacket is formed along a lateral side surface of the protruding portion in the protruding portion to fluid-connect the upper water jacket with the lower water jacket.

3. The cylinder head of claim 2, wherein the connection water jacket is formed in the protruding portion except for a portion that the exhaust outlet portion is formed.

4. The cylinder head of claim 1, wherein the connection water jacket is formed in the protruding portion except for a portion that the exhaust outlet portion is formed.

5. The cylinder head of claim 1, wherein the exhaust outlet portion is formed at a central portion of the outer surface of the protruding portion and the connection water jacket is disposed at both sides of the exhaust outlet portion along a longitudinal direction of the protruding portion.

6. The cylinder head of claim 1, wherein the exhaust outlet portion includes at least an exhaust outlet that are disposed in a line with a predetermined distance along a longitudinal direction of the protruding portion.

7. The cylinder head of claim 1, wherein the connection water jacket is formed by forming a drill hole in the protruding portion from the upper surface to the lower surface thereof to connect the upper and lower water jackets.

8. The cylinder head of claim 7, further comprising a cap closing an opened portion of the drill hole.

9. The cylinder head of claim 1, wherein a coolant hole is formed in a lateral side surface of the protruding portion to fluid-communicate with the connection water jacket.

10. The cylinder head of claim 9, further comprising a cover that is mounted on the protruding portion to close the coolant hole and to form the connecting water jacket therein.

11. The cylinder head of claim 10, wherein a flange surface is formed along the coolant hole in the lateral side surface of the protruding portion and the cover is attached on the flange surface.

12. The cylinder head of claim 1, wherein the protruding portion is monolithically formed with the cylinder head.

13. A manufacturing method of a cylinder head having a water jacket, comprising:
disposing a first core corresponding to an upper water jacket inside a mold;
disposing a second core corresponding to a lower water jacket;
disposing a third core corresponding to a connection water jacket connecting ends of the upper water jacket and the lower water jacket;
disposing a core print supporting the third core;
injecting molten metal into the mold;
eliminating the core print supporting the third core; and
inserting a tapered plug through a hole formed by drawing out the core print.
